(19) United States
(12) Patent Application Publication
(10) Pub. No.: US 2014/0216660 A1
(43) Pub. Date: Aug. 7, 2014

(54) Transfer Ring Shoe and Transfer Ring Having Varied Shoe Profile

(71) Applicant: Davian Enterprises, LLC, Greenback, TN (US)

(72) Inventors: Patrick Jones, Sarasota, FL (US); Ian Smith, Maryville, TN (US); William Jones, West Midlands (GB); Robert L. Marcus, JR., Knoxville, TN (US)

(73) Assignee: Davian Enterprises, LLC, Greenback, TN (US)

(21) Appl. No.: 13/964,387

(22) Filed: Aug. 12, 2013

Related U.S. Application Data
(60) Provisional application No. 61/681,917, filed on Aug. 10, 2012.

(51) Int. Cl. B29D 30/26

(52) U.S. Cl. CPC B29D 30/2607
USPC 156/406.2

(57) ABSTRACT

A transfer ring of the type having a plurality of shoes arranged in a substantially circular configuration to define an inwardly-facing segmented cylindrical gripping surface, and a shoe for use in such a transfer ring, are disclosed. Each shoe comprises an arcuate interior surface defining a segment of the cylindrical gripping surface. The interior surface of each shoe has a first arcuate edge and an opposite second arcuate edge arranged substantially parallel to one another, and opposite first and second end edges extending between respective ends of said first and second arcuate edges. Each first and second end edge defines a substantially non-linear shape with each first and second end edge being shaped for mating engagement with an end edge of an adjacent shoe in the circular configuration.

### CROSS-REFERENCE TO RELATED APPLICATIONS

This application claims the benefit of U.S. Provisional Application No. 61/681917, filed on Aug. 10, 2012.

### STATEMENT REGARDING FEDERALLY-SPONSORED RESEARCH OR DEVELOPMENT

Not Applicable

### BACKGROUND OF THE INVENTION

1. Field of Invention

The present general inventive concept relates to devices that are useful in the manufacture of vehicle tires. More particularly, the present general inventive concept relates to an improved transfer ring useful in the manufacture of vehicle tires.

2. Description of the Related Art

The manufacture of a vehicle tire commonly includes the steps of forming a tire carcass, forming a toroid-shaped belt and tread “package” of the tire separately from the carcass, and thereafter marrying the belt and tread package to the tire carcass to form a “green” tire. The green tire is thereafter treated to form the tread and various other features of a finished tire. Other supplementary steps, such as bonding the belt and tread package to the tire carcass (often referred to as “stitching” the belt and tread package), may be performed during the course of, or following, one or more of the aforementioned steps.

Formation of a belt and tread package of a tire is typically accomplished using a belt and tread drum, of the type disclosed in U.S. Pat. No. 6,013,147. Such a belt and tread drum typically has an outer cylindrical surface, or circumference, about which one or more layers of the tire belt material (comprising, for example, reinforcement cords embedded in a polymeric binder) are laid to define the belt and tread package. The circumference of the belt and tread drum is preferably capable of expanding and contracting to allow, for example, removal of a completed belt and tread package from the drum. A completed belt and tread package is typically essentially nonexpandable radially. However, a completed belt and tread package is typically flexible to the extent that, when unsupported, the toroid-shaped belt and tread package will deform and sag under the influence of gravity. Also, desirably, the adjustable circumference of the belt and tread drum enables a single drum to be used to form belt and tread packages of alternative diameters.

In the manufacture of vehicle tires, a tire carcass is typically fabricated using a tire building drum, of the type described in U.S. Pat. No. 6,457,505. Such a tire building drum typically defines a radially expandable and contractible cylindrical working surface, similar to the above-discussed belt and tread drum, upon which a tire carcass is formed. Subsequent to the formation of the tire carcass on the cylindrical working surface, such tire carcass typically is transferred to an expansion drum, of the type discussed in U.S. Pat. No. 6,602,372. The tire carcass is positioned surrounding the expansion drum, and a portion of the tire carcass is overlaid with the belt and tread package. The tire carcass is then inflated to a toroid shape resembling, though often not identical to, the shape of a finished tire. While the tire carcass is inflated, the belt and tread package is stitched to the tire carcass.

In the above-described process, the steps of transferring a tire carcass from a tire building drum to an expansion drum and transferring a belt and tread package to a tire carcass for stitching are typically both accomplished using one or more transfer rings, of the type described in U.S. Pat. No. 8,091,602. Such a transfer ring typically includes a plurality of “shoe” segments having arced interior surfaces which collectively form a radially-inwardly-facing cylindrical surface suitable for grasping and holding a tire carcass and/or a belt and tread package. Each shoe segment is mounted on an appropriate linkage such that the shoes are collectively radially expandable and contractible with respect to one another, such that the diameter of the radially-inwardly-facing cylindrical surface can be expanded to fit over a tire carcass and/or belt and tread package, contracted to grasp the tire carcass or belt and tread package for transfer, and then re-expanded to release the tire carcass or belt and tread package following transfer.

When a transfer ring is used as described above to transfer a tire carcass and/or belt and tread package (hereinafter, collectively, “tire component,”), it is not uncommon for the transfer ring to be configured such that the shoes apply considerable pressure to exterior surfaces of the tire component, in part to assist in maintaining a uniform toroid shape of the tire component during transfer. Such high pressures applied to the exterior surfaces of the tire component can result in at least a portion of the arced interior surfaces of the shoes becoming imprinted in the tire component, resulting in the formation of imprints of the interior surfaces of the shoes, and corresponding bulges adjacent the imprints, in the tire component. When a finished tire that includes these imprints and corresponding bulges rolls across a surface, sequential contact of the alternating imprints and bulges in the tire components with the surface can, in certain circumstances, result in undesirable performance features of the finished tire, such as for example vibration and/or resonance of the rolling tire. Such vibration and/or resonance can result in undesirable noise and/or shaking of the tire, increased wear and shortened life of the tire, and in some extreme instances, catastrophic failure of the tire.

In several designs of transfer rings, the above-discussed problem of resonance of a finished tire due to sequential contact between a surface on which the tire is rolled and bulges and imprints of shoe interior surfaces on the tire components is partially addressed by providing a prime number of shoes to form the radially-inwardly-facing cylindrical surface of the transfer ring. For example, in certain transfer ring designs, eleven shoes are provided to define the radially-inwardly-facing cylindrical surface of the transfer ring. In other designs, thirteen shoes are provided to define the radially-inwardly-facing cylindrical surface of the transfer ring. By providing a prime number of shoes to form the radially-inwardly-facing cylindrical surface, the same prime number of resultant imprints and corresponding bulges are formed in the transferred tire components. Thus, the ability for the tire to establish a resonating frequency when rolling across a surface due to sequential contact of the alternating imprints and bulges against the surface is limited to certain frequencies which are compatible with the prime number of shoes of the transfer ring. In many tire designs, such compatible frequencies result in low amounts of vibration at typical operating speeds of the tire. However, in several designs, vibration at such frequencies which is sufficient to disrupt performance of the tire is attainable at certain high speeds of the tire. The high speeds necessary to establish such vibrations are typically outside of the range of speeds for which the particular tire is recommended for use.

Notwithstanding the above, in certain high-speed tire applications, such as for example certain applications of tires used in the landing gear for aircraft, it is possible for tires which were formed using transfer rings having a prime number of shoes to be rolled at speeds which allow for the development of sufficient resonation of the tire which is strong enough to negatively impact performance of the tire and/or to reduce the overall effective life of the tire. Accordingly, a tire transfer ring which includes alternate or additional features for limiting resonance of a tire manufactured using the transfer ring is desired.

### BRIEF SUMMARY OF THE INVENTION

According to certain features of the present general inventive concept, a shoe for a transfer ring of the type having a plurality of shoes arranged in a substantially circular configuration to define an inwardly-facing segmented cylindrical gripping surface is provided. The shoe may comprise an arcuate interior surface defining a segment of the cylindrical gripping surface. The interior surface may have an arcuate first side edge and an opposite arcuate second side edge arranged substantially parallel to one another and opposite first and second end edges extending between respective ends of the first and second side edges. At least a portion of each first and second end edge may extend non-parallel to an axial dimension of the cylindrical gripping surface. The shoe may further comprise at least one connector member extending opposite the arcuate interior surface, with the connector member defining at least one connector portion for connecting the shoe to a transfer ring.

According to certain features of the present general inventive concept, each first and second end edge may define a non-linear shape. In certain embodiments, each first end edge may be keyed to mate with the second end edge, such that the shoe may mate along a first end edge of the shoe with a second end edge of an adjacent shoe. In certain embodiments, each of the first and second end edges may define a plurality of alternating protrusions and recesses extending generally along a circumferential dimension of said cylindrical gripping surface. For example, in one embodiment, each of the first and second end edges may have a first end portion extending substantially perpendicular to the first side edge and an opposite second end portion extending substantially perpendicular to the second side edge. Each of the first and second end edges may have a central portion extending between the first and second end portions at an angle oblique to the axial dimension of the cylindrical gripping surface. In one embodiment, the first end edge may define a first protrusion at an intersection of the first end edge with the first side edge and a first recess at an intersection of the first end edge with the second side edge. The second end edge may define a second protrusion at an intersection of the second end edge with the second side edge and a second recess at an intersection of the second end edge with the first side edge.

According to certain features of the present general inventive concept, a transfer ring is provided for use in a system for the manufacture of vehicle tires. In certain embodiments, the transfer ring may comprise a radially expandable and collapsible segmented cylindrical gripping surface defined by a plurality of shoes of the type described herein. Each shoe may be mounted for radial movement toward and away from a central axis of the cylindrical gripping surface between a contracted position and an expanded position. In certain embodiments, the transfer ring may comprise a circular frame, as well as a plurality of elongated driven links, each driven link having a first end rotatably mounted along the circular frame such that each driven link is rotatable between a contracted position and an expanded position. The transfer ring may also include a drive member disposed along the circular frame, the drive member being in operable engagement with the driven links and configured to drive the driven links between the contracted position and the expanded position. In these embodiments, each shoe may be rotatably mounted to one of the driven links at a second end thereof.

In some embodiments, each shoe may have an arcuate interior surface defining a segment of the cylindrical gripping surface. Each interior surface may have an arcuate first side edge and an opposite arcuate second side edge arranged substantially parallel to one another, and opposite first and second end edges extending between respective ends of the first and second side edges. Each first and second end edge may have at least a portion thereof extending non-parallel to the central axis of the cylindrical gripping surface. In some embodiments, each first end edge of one of the plurality of shoes may be mounted adjacent a second end edge of an adjacent shoe. As discussed above, in certain embodiments, each of the first and second end edges may define a plurality of alternating protrusions and recesses extending generally along a circumferential dimension of said cylindrical gripping surface. In certain embodiments, each first protrusion of each shoe may extend sufficiently along a circumferential dimension of the cylindrical gripping surface as to overlap said second protrusion of the adjacent shoe along a zone parallel to the central axis of the cylindrical gripping surface. In certain embodiments, each first end edge of each shoe may define a shape which differs from the first end edges of the remaining shoes, with each second end edge of each shoe being keyed to a first end edge of an adjacent shoe.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of one embodiment of a transfer ring constructed in accordance with several features of the present general inventive concept, showing the transfer ring in a contracted position;

FIG. 2 is a perspective view of the transfer ring of FIG. 1, showing the transfer ring in an expanded position;

FIG. 3 is a partial perspective view showing a portion of the transfer ring of FIG. 1;

FIG. 4 is an exploded view of the transfer ring of FIG. 1;

FIG. 5 is a partial-cutaway side view of the transfer ring of FIG. 1;

FIG. 6 is a perspective view of one embodiment of a shoe constructed in accordance with several features of the present general inventive concept;

FIG. 7 is a perspective view showing a plurality of shoes constructed in accordance with several features of the present general inventive concept;

FIG. 8 is a plan view of one embodiment of a plurality of shoes constructed in accordance with several features of the present general inventive concept;

FIG. 9 is a plan view of another embodiment of a plurality of shoes constructed in accordance with several features of the present general inventive concept;

FIG. 10 is a plan view showing several additional embodiments of shoes constructed in accordance with several features of the present general inventive concept; and

FIG. 11 is a perspective view of another embodiment of a shoe constructed in accordance with several features of the present general inventive concept.

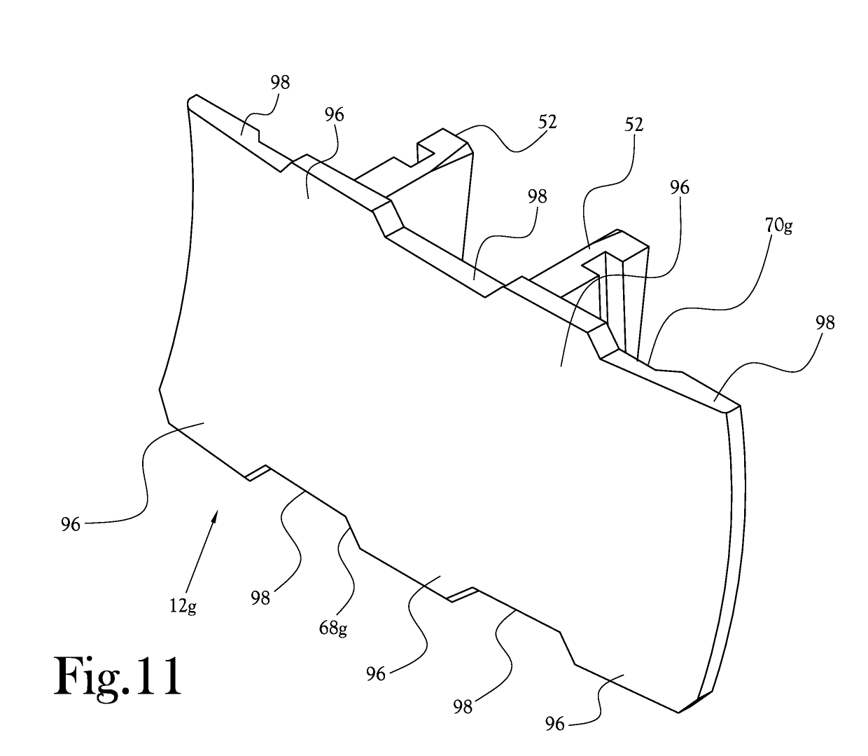

### DESCRIPTION OF THE INVENTION

According to several features of the present general inventive concept, a shoe for use in a transfer ring and a transfer ring having a varied shoe profile are disclosed. The transfer ring having a varied shoe profile, or transfer ring, is identified at 10 herein and in the accompanying figures. As will be further described hereinbelow, the transfer ring 10 includes a plurality of shoes 12, each of which defines varied profiles along end edges thereof such that the shoes 12 cooperate to produce a less uniform pattern of alternating imprints and bulges in a tire component during use of the transfer ring 10 to transfer the tire component.

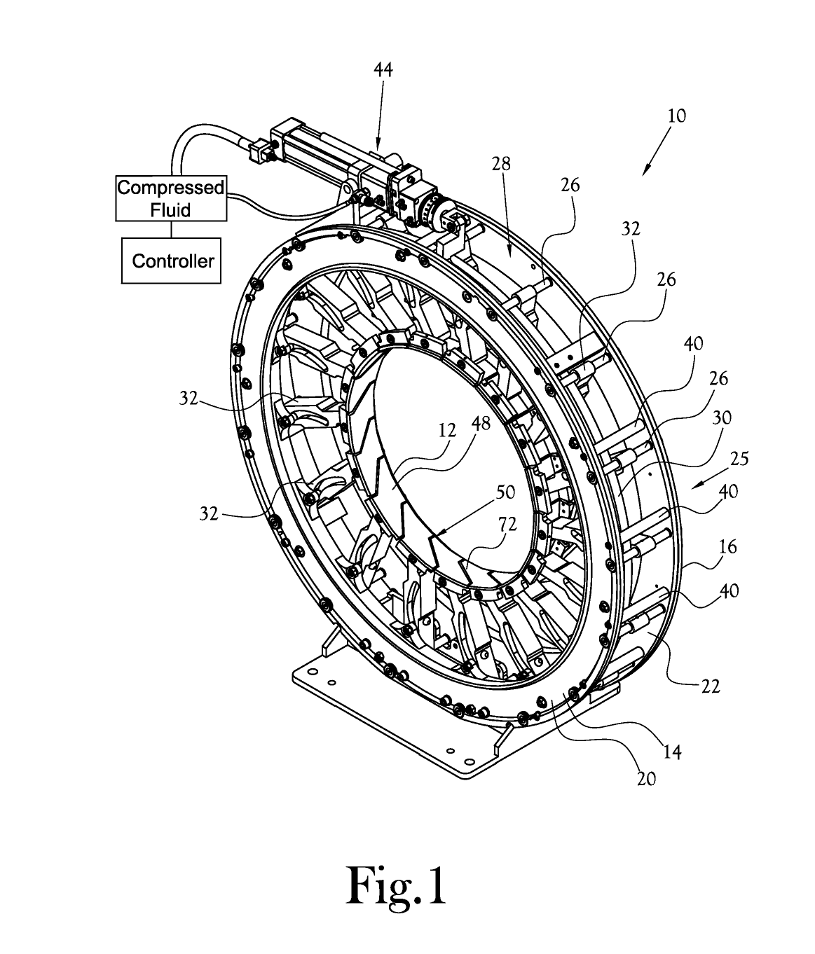

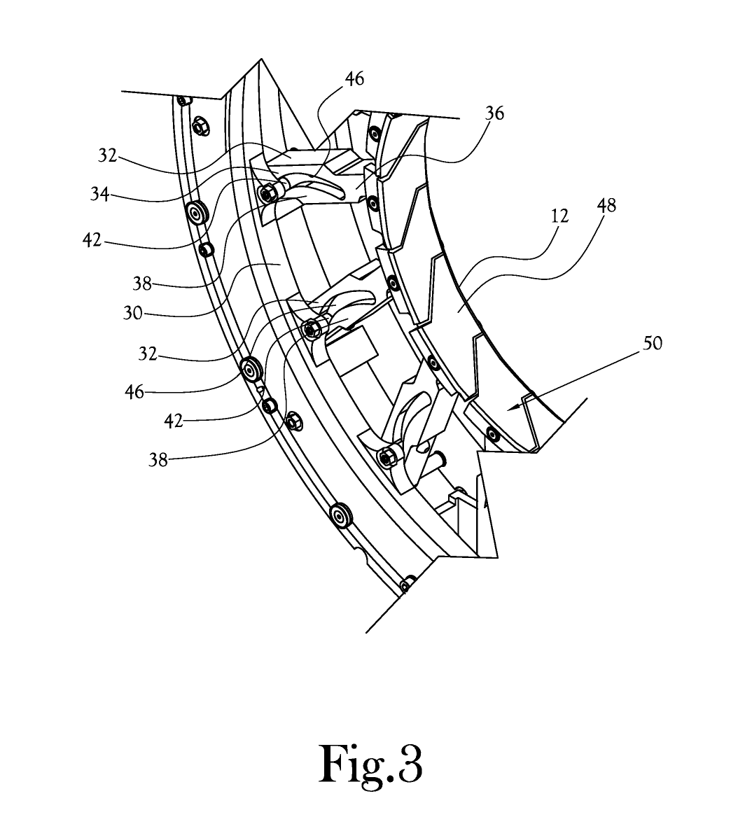

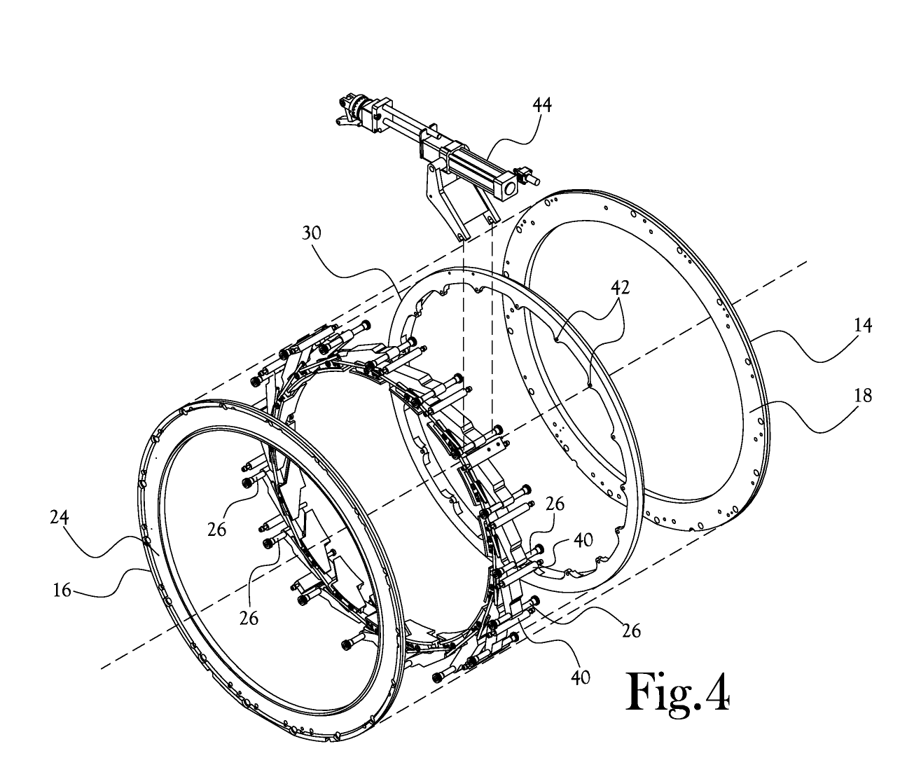

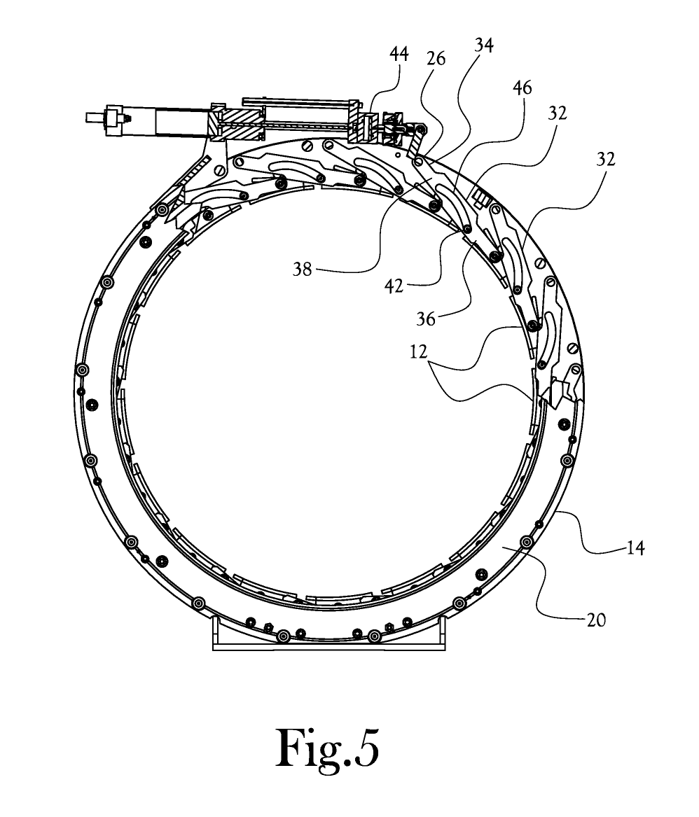

With initial reference to FIGS. 1-5, in one embodiment, a transfer ring 10 includes first and second circular frame members 14, 16, respectively, disposed in a fixed, registered, side-by-side, parallel, and spaced apart relationship to one another. The first and second circular frame members 14, 16 are of substantially the same inner and outer diameters, and each is preferably of a generally rectangular cross-section having respective inner and outer opposite flat side surfaces 18, 20 and 22, 24, respectively. A plurality of hinge pin connectors 26 extend between the first and second circular frame members 14, 16 at spaced apart locations about the respective perimetral margins of the first and second circular frame members 14, 16 to rigidly retain the side-by-side, parallel, registered, and spaced apart relationship of the first and second circular frame members 14, 16, thereby defining a skeletal cage 25 having an open space 28 between the first and second circular frame members 14, 16.

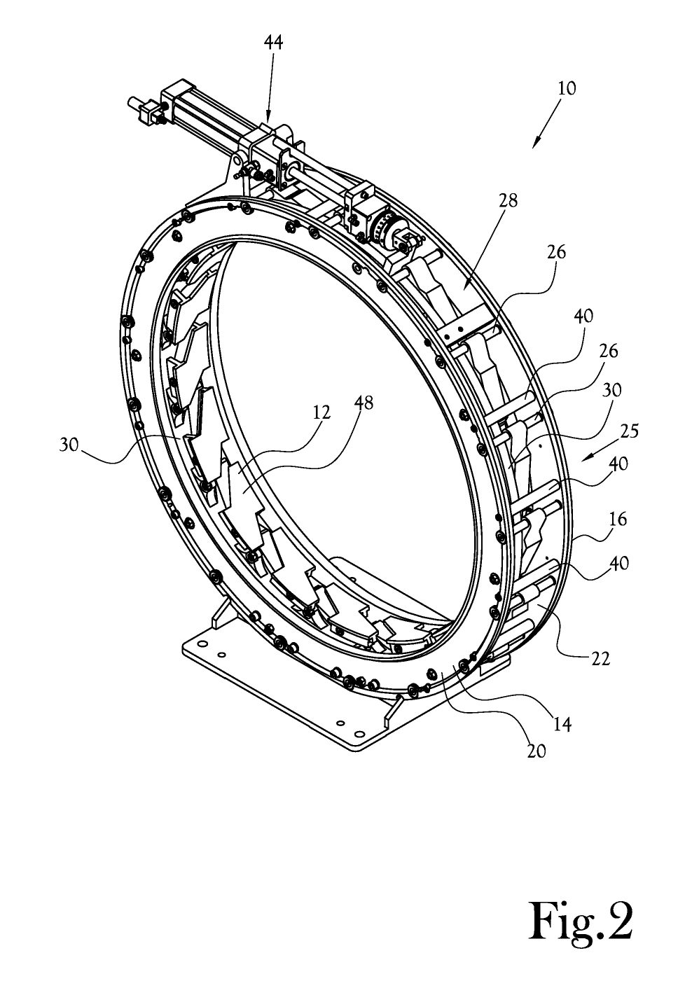

Within the open space 28 of the skeletal cage 25, there is disposed a circular drive member 30 mounted in side-by-side, parallel, and coaxial relationship to the first and second circular frame members 14, 16, via a plurality of rollers 40 extending between the first and second circular frame members 14, 16, such that the drive member 30 is rotatable about a central axis of the drive member 30 with respect to the skeletal cage 25. Referring to FIGS. 1, 3, and 5, a plurality of driven links 32 are also provided within the open space 28 of the skeletal cage 25. Each driven link 32 is of an elongated geometry, having a first end 34 which is hingedly mounted on a respective hinge pin connector 26 extending between the first and second circular frame members 14, 16, and a second end 36 which extends generally inwardly of the skeletal cage 25. Each driven link 32 further defines a first side surface 38 extending parallel to the inner and outer opposite flat side surfaces 18, 20 and 22, 24 of the first and second circular frame members 14, 16. An elongated camming groove 46 is defined in each first side surface 38 of each driven link 32 and extends generally along the length of the driven link 32. Each camming groove 46 has, operatively received therein, one of a plurality of roller cam followers 42 which are disposed at locations about the drive member 30 and extend generally parallel to the central axis of the drive member 30, toward the driven links 32. A power source 44, such as the piston/cylinder device illustrated in FIG. 1, is provided for effecting controlled rotation of the drive member 30 in relation to the skeletal cage 25. Thus, actuation of the power source 44 results in rotational movement of the drive member 30 in relation to the skeletal cage 25, which in turn moves each cam follower 42 along its respective camming groove 46, thereby rotating each driven link 32 about its respective hinge pin connector 26 between a contracted position (see FIG. 1), in which each second end 36 of each driven link 32 extends generally radially inwardly toward a central axis of the drive member 30 and the first and second circular frame members 14, 16, and an expanded position (see FIG. 2), in which each second end 36 of each driven link 32 extends generally along a circumference of the drive member 30.

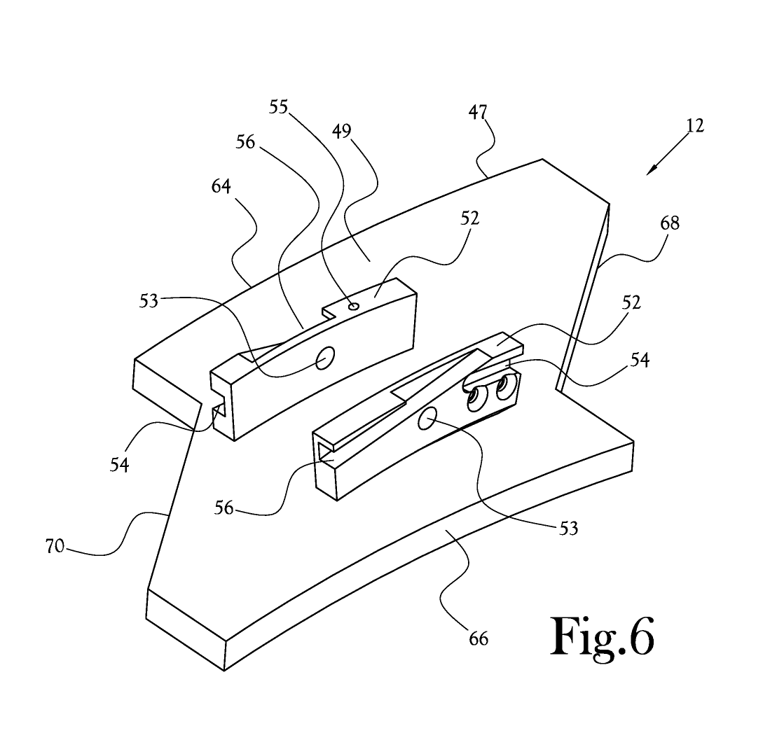

Referring to FIGS. 1-3 and 6-8, and as mentioned above, a plurality of articulating shoes 12 are provided, with one shoe 12 being hingedly attached to the second end 36 of each of the driven links 32 along a dimension parallel to the central axis of the skeletal cage 25. As is illustrated in FIGS. 6-8, each shoe 12 includes an arcuate plate 47 having an arcuate interior surface 48 facing substantially radially inwardly of the skeletal cage 25 and an arcuate outer surface 49 facing substantially radially outwardly of the skeletal cage 25. Each arcuate plate 47 defines first and second arcuate side edges 64, 66, respectively, as well as first and second end edges 68, 70, respectively, which extend at opposite ends of the arcuate plate 47 between the first and second side edges 64, 66. The various shoes 12 are arranged in an end-to-end configuration with each first end edge 68 of each plate 47 extending generally along a second end edge 70 of an adjacent plate 47, such that the various arcuate interior surfaces 48 of the plates 47 of the shoes 12 cooperate to collectively establish a segmented cylindrical surface 50 which, as will be further discussed below, is adapted to surround and grasp an object, such as for example a tire component.

FIG. 6 illustrates a perspective view of the outer surface 49 of one shoe 12 of the present embodiment. As shown in FIG. 6, each shoe 12 further includes at least one wall 52 extending outwardly from the plate 47 generally perpendicular to the outer surface 49. In the illustrated embodiment, a pair of walls 52 extend outwardly from the plate 47 at a parallel, spaced apart orientation to one another along an arcuate dimension of the plate 47. The walls 52 are spaced apart from one another a suitable distance to allow the second end 36 of one of the driven links 32 to be inserted therebetween. Suitable fastening means, such as for example a plurality of axially-aligned through openings 53, are provided along the walls 52 and through each driven link second end 36 to allow receipt therein of a pin, bolt, or other such rotatable connector, so as to allow each shoe 12 to be rotatably connected to a corresponding driven link second end 36. In the illustrated embodiment, an internally-threaded set screw opening 55 is provided opening perpendicular to an axial dimension of one of the through openings 53, such that upon receipt of a pin connector through the through openings 53 in the walls 52 and the driven link second end 36, a set screw (not shown) may be received within the set screw opening 55 to secure the pin connector through the through openings 53. However, it will be understood that other suitable configurations exist which may be used to achieve a rotatable connection between each shoe 12 and a corresponding driven link second end 36, and such other configurations may be used without departing from the spirit and scope of the present general inventive concept.

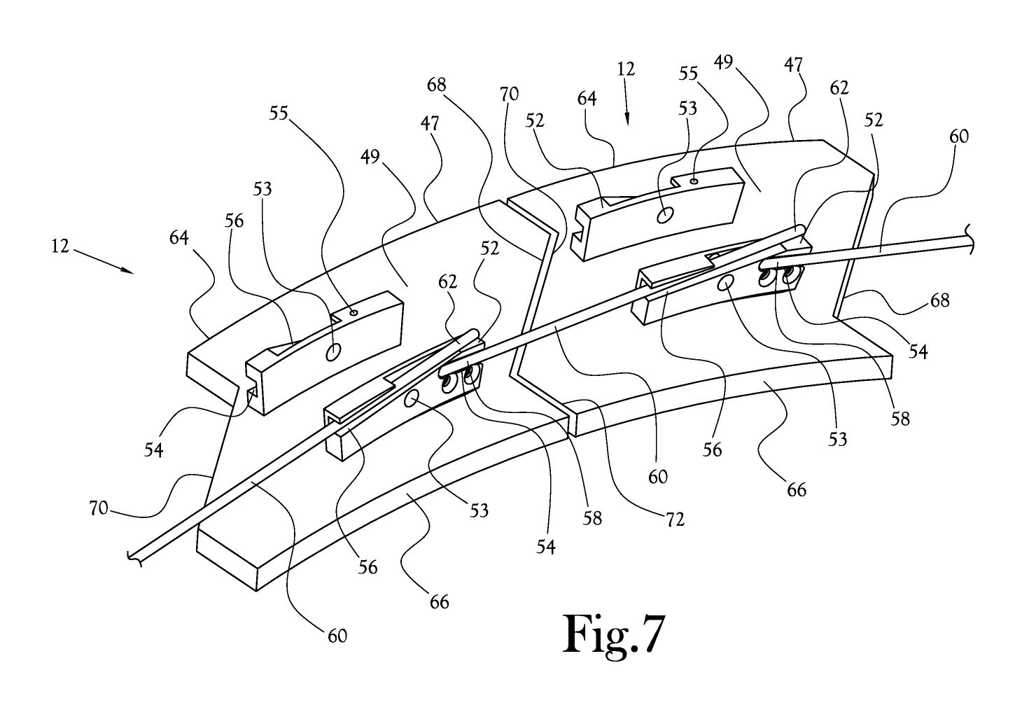

Referring to FIGS. 6 and 7, first and second grooves 54, 56 are defined along each wall 52 of each shoe 12, with each first groove 54 having at least one open end which opens toward an adjacent shoe, and with each second groove 56 having at least one open end which opens toward an opposite adjacent shoe. The first groove 54 is adapted to receive therein a first end 58 of a rigid guide rod 60 of sufficient length to span two adjacent ones of the shoes 12. The first end 58 of each guide rod 60 is anchored within its respective first groove 54 by a suitable fastener, such as for example a screw, bolt, weld, adhesive, or other fastener, or by an integral connection. An opposite second end 62 of each guide rod 60 extends into and is slidably received within the second groove 56 of an adjacent shoe.

Referring again to FIGS. 1-3, as discussed above, the second ends 36 of the driven links 32 are configured to rotate between the expanded position and the collapsed position upon appropriate rotation of the drive member 30 in relation to the skeletal cage 25. Thus, upon rotation of the second ends 36 of the driven links 32 to the expanded position, the shoes 12 are carried by the second ends 36 of the driven links 32 to an expanded configuration, wherein the interior surfaces 48 of the shoes are separated from one another to increase the overall diameter of the segmented cylindrical surface 50. Conversely, upon rotation of the second ends 36 of the driven links 32 to the contracted position, the shoes 12 are carried by the second ends 36 of the driven links 32 to a contracted configuration, wherein the interior surfaces 48 of the shoes are brought closer to one another to decrease the overall diameter of the segmented cylindrical surface 50. To this end, and with reference again to FIGS. 6 and 7, each of the first and second grooves 54, 56 is oriented with respect to one another such that each of the guide rods 60 slide along its respective second groove 56 to cooperatively maintain the interior surfaces 48 of the shoes 12 with respect to one another in a generally cylindrical configuration throughout the above-discussed expansion and contraction of the shoes 12 between the expanded configuration and the collapsed configuration.

With reference to FIGS. 6-8, according to one feature of the present general inventive concept, in several embodiments, the various end edges 68, 70 of the arcuate plates 47 of the shoes 12 each extend, at least in part, in a direction non-parallel to an axial dimension of the segmented cylindrical surface 50. In several embodiments, the various end edges 68, 70 of the arcuate plates 47 of the shoes 12 each define a non-linear, irregular, and/or varied shape, such that when the shoes 12 are positioned adjacent one another in the contracted position to form the segmented cylindrical surface 50, each seam 72 formed between adjacent shoes 12 extends along an irregular path which is, at least in part, non-parallel to an axial dimension of the segmented cylindrical surface 50. As will be further discussed below, such configuration of the seams 72 between adjacent shoes in an orientation at least partially non-parallel to the axial dimension of the segmented cylindrical surface 50 assists in limiting the formation of resonance or vibration of a finished tire manufactured using the transfer ring 10.

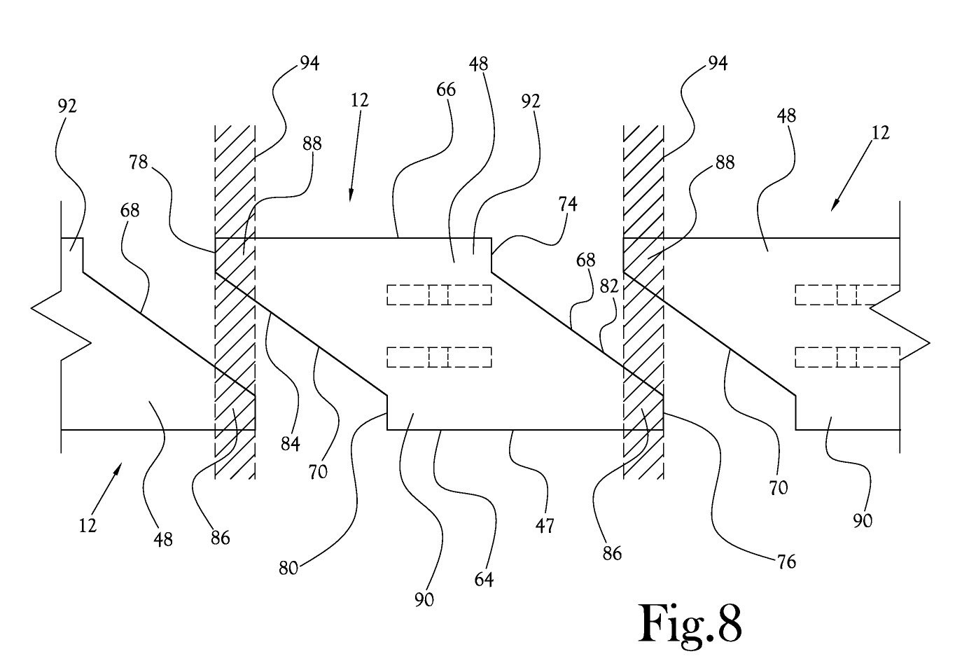

In several embodiments, the end edges 68, 70 of the arcuate plates 47 are shaped such that the plates 47 define a plurality of alternating protrusions 86, 88 and recesses 90, 92 extending along the circumference of the segmented circumferential surface 50. For example, in the embodiment of FIG. 8, each of the first and second end edges 68, 70 of each plate 47 defines first and second exterior portions 74, 76, 78, 80 which extend at a generally right angles to corresponding adjacent first and second side edge 64, 66 of the shoe 12. Central portions 82, 84 of each of the first and second end edges 68, 70 of each shoe 12 extend generally at an oblique angle to an axial dimension of the segmented cylindrical surface 50 between corresponding first and second exterior portions 74, 76, 78, 80. More specifically, a first central portion 82 of the first end edge 68 extends between corresponding first and second exterior portions 74, 76 of the first end edge 68 at an oblique angle to an axial dimension of the segmented cylindrical surface 50. Likewise, a second central portion 84 of the second end edge 70 extends between corresponding first and second exterior portions 78, 80 of the second end edge 70 at a substantially similar oblique angle, generally parallel to the first central portion 82. Thus, each arcuate plate 47, at an intersection of the first end edge 68 with the first side edge 64 thereof, defines a first protrusion 86 which extends along the circumference of the segmented cylindrical surface 50. A second protrusion 88 is defined at an intersection of the second end edge 70 with the second side edge 66, and extends along the circumference of the segmented circumferential surface 50 in a direction opposite to the first protrusion 86. A first recess 90 is defined at an intersection of the first side edge 64 with the second end edge 70, and a second recess 92 is defined at an intersection of the second side edge 66 with the first end edge 68.

As discussed above, the various interior surfaces 48 of the shoes 12 in the transfer ring 10 are adapted to fit together in a mating relationship along respective adjacent end edges 68, 70 when the transfer ring 10 is in the contracted position (FIG. 1) to form the segmented cylindrical surface 50. Accordingly, in the present embodiment, the first protrusion 86 of each shoe 12 is keyed to mating engagement with the first recess 90 of an adjacent shoe 12, and the second recess 92 of each shoe 12 is keyed to mating engagement with the second protrusion 88 of the adjacent shoe 12. In the illustrated embodiment, each of the central portions 82, 84 of the first and second end edges 68, 70 extends along substantially the same oblique angle to the central axis of the segmented cylindrical surface 50, and thus, each first central portion 82 is keyed to the second central portion 84 of an adjacent shoe 12, and vice versa.

FIG. 8 illustrates a plan view showing multiple shoes 12 arranged in an end-to-end configuration, with the shoes 12 being spaced apart from one another to resemble the expanded position of the transfer ring 10. As can be seen in FIG. 8, in several embodiments, when the various shoes 12 are arranged in the expanded position, the first protrusion 86 of each shoe 12 extends sufficiently along the circumference of the expanded segmented cylindrical surface 50 as to overlap the second protrusion 88 of the adjacent shoe 12 along a zone 94 parallel to the axial dimension of the cylindrical surface 50. Thus, in the event a tire component is held within the cylindrical surface 50 in the expanded position of the transfer ring 10, at least one shoe 12 may overlie the tire component about the entire circumference of the tire component.

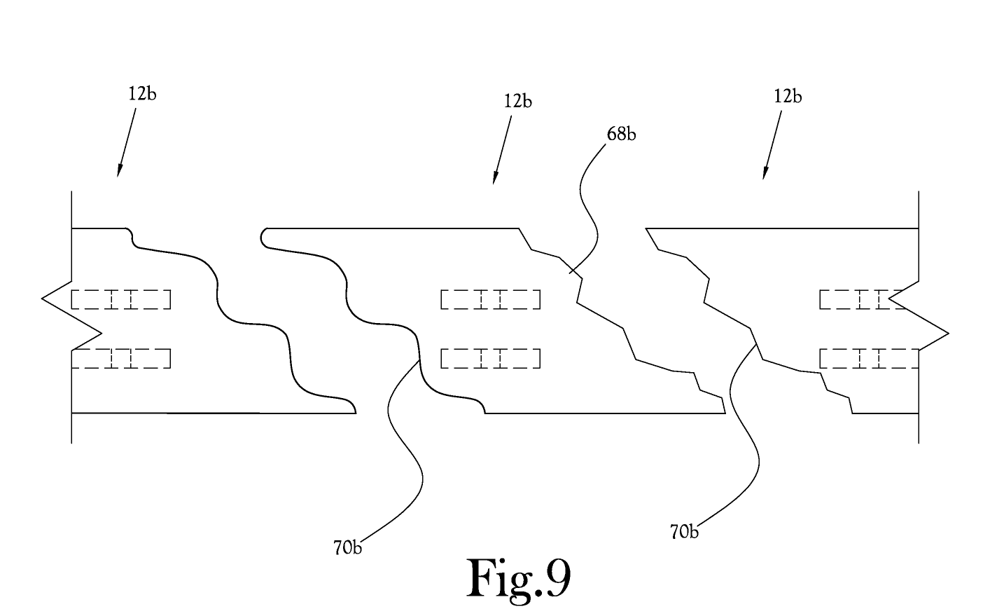

In the illustrated embodiment, the profiles of the first and second end edges 68, 70 of each of the plates 47 are depicted as being symmetrical to one another about a central point of the plate 47. However, it will be understood that such symmetry is not necessary to accomplish the present general inventive concept. For example, FIG. 9 illustrates a plurality of shoes 12b constructed in accordance with several features of the present general inventive concept. In the embodiment of FIG. 9, each first end edge 68b of each shoe 12b about the cylindrical surface 50b defines a unique shape which differs from the shapes of the first end edges of the remaining shoes 12b, such as for example a sinusoidal shape, a wave shape, a puzzle shape, a zigzag or jagged shape, a combination thereof, of the like. Each second end edge 70b of each shoe 12b is shaped to conform to the shape of the first end edge 68b of an adjacent shoe 12b for mating engagement with the adjacent shoe.

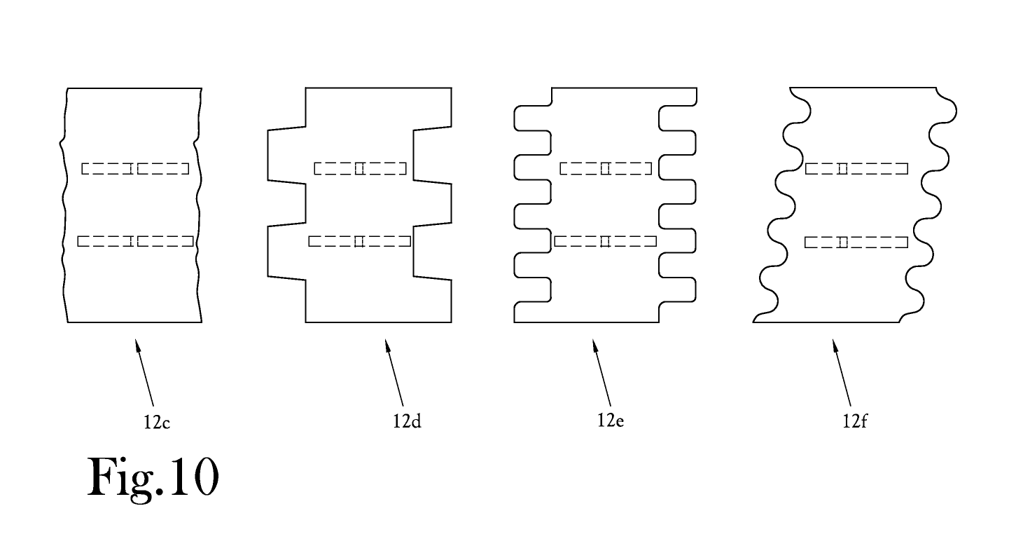

In light of the above, it will be understood that the shape defined by each end edge 68, 70 of the various shoes 12 of a transfer ring 10 may vary, provided that the shoes are shaped to generally matingly engage one another to form the segmented cylindrical surface 50 of the transfer ring 10. For example, FIG. 10 illustrates several possible shapes suitable for use in forming the interior surfaces 48 of the shoes 12. As shown in FIG. 10, in one embodiment, each shoe 12c includes first and second end edges which define irregular, jagged profiles. In other embodiments, such as the embodiments depicted at 12d-f, each shoe includes first and second end edges which define a series of regularly-spaced protrusions with matching recesses defined therebetween.

FIGS. 6-8 illustrate another embodiment of a shoe 12g constructed in accordance with several features of the present general inventive concept. In the embodiment of FIGS. 6-8, a first end edge 68g of each shoe 12g defines a series of trapezoidal-shaped protrusions 96, with similarly-shaped trapezoidal recesses 98 defined therebetween. As in the previous embodiments described above, each second end edge 70g of each shoe 12g defines similar protrusions 96 and recesses 98 positioned along the second end edge 70g such that the second end edge 70g is shaped to conform to the shape of the first end edge 68g of an adjacent shoe 12g for mating engagement with the adjacent shoe.

It will be recognized that, in the use of a transfer ring 10 to grasp and transport tire components, in which the transfer ring 10 employs shoes 12 having varied profiles along the end edges 68, 70 thereof as described above, in the event such shoes 12 are made to grasp a tire component with sufficient force to produce imprints of the shoes and/or bulges between the shoes in the tire component, the general shape and orientation of the bulges along the tire component will generally follow the varied profiles of the first and second end edges 68, 70 of the shoes 12. Accordingly, by imprinting bulges along the tire component having varied profiles and/or orientation, regular spacing and/or orientation of bulges along the tire component is disrupted, thereby reducing the likelihood that harmonic resonance and/or other vibration will occur in a finished tire comprising the tire component.

While the present invention has been illustrated by description of several embodiments and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, what is claimed is:

1. A shoe for a transfer ring of the type having a plurality of said shoes arranged in a substantially circular configuration to define an inwardly-facing segmented cylindrical gripping surface, said shoe comprising:
an arcuate interior surface defining a segment of the cylindrical gripping surface, said interior surface having an arcuate first side edge and an opposite arcuate second side edge arranged substantially parallel to one another and opposite first and second end edges extending between respective ends of said first and second side edges, each said first and second end edge having at least a portion thereof extending non-parallel to an axial dimension of said cylindrical gripping surface; and
at least one connector member extending opposite said arcuate interior surface, said connector member defining at least one connector portion for connecting said shoe to a transfer ring.

2. The shoe of claim 1, each said first and second end edge defining a non-linear shape.

3. The shoe of claim 1, said first end edge being keyed to mate with said second end edge, such that said shoe may mate along said first end edge with a second end edge of an adjacent shoe.

4. The shoe of claim 3, each said first and second end edges defining a plurality of alternating protrusions and recesses extending generally along a circumferential dimension of said cylindrical gripping surface.

5. The shoe of claim 4, each said first and second end edges having a first end portion extending substantially perpendicular to said first side edge and an opposite second end portion extending substantially perpendicular to said second side edge.

6. The shoe of claim 5, each said first and second end edges having a central portion extending between said first and second end portions at an angle oblique to said axial dimension of said cylindrical gripping surface.

7. The shoe of claim 6, said first end edge defining a first protrusion at an intersection of said first end edge with said first side edge and a first recess at an intersection of said first end edge with said second side edge, said second end edge defining a second protrusion at an intersection of said second end edge with said second side edge and a second recess at an intersection of said second end edge with said first side edge.

8. A transfer ring for use in a system for the manufacture of vehicle tires, said transfer ring comprising:
a radially expandable and collapsible segmented cylindrical gripping surface defined by a plurality of shoes, each said shoe being mounted for radial movement toward and away from a central axis of said cylindrical gripping surface between a contracted position and an expanded position, each said shoe having an arcuate interior surface defining a segment of said cylindrical gripping surface, each said interior surface having an arcuate first side edge and an opposite arcuate second side edge arranged substantially parallel to one another and opposite first and second end edges extending between respective ends of said first and second side edges, each said first and second end edge having at least a portion thereof extending non-parallel to said central axis of said cylindrical gripping surface.

9. The transfer ring of claim 8, each first end edge of one of said plurality of shoes being mounted adjacent a second end edge of an adjacent shoe.

10. The transfer ring of claim 9, each said first end edge of each shoe being shaped to mate with said second end edge of said adjacent shoe.

11. The transfer ring of claim 10, each said first and second end edge of each said shoe defining a non-linear shape.

12. The transfer ring of claim 11, each said first and second end edges of each said shoe defining a plurality of alternating protrusions and recesses extending generally along a circumferential dimension of said cylindrical gripping surface.

13. The transfer ring of claim 9, each said first and second end edges of each said shoe having a first end portion extending substantially perpendicular to said first side edge and an opposite second end portion extending substantially perpendicular to said second side edge.

14. The transfer ring of claim 13, each said first and second end edges of each said shoe having a central portion extending between said first and second end portions at an angle oblique to said central axis of said cylindrical gripping surface.

15. The transfer ring of claim 14, each said first end edge of each said shoe defining a first protrusion at an intersection of said first end edge with said first side edge and a first recess at an intersection of said first end edge with said second side edge, each said second end edge of each said shoe defining a second protrusion at an intersection of said second end edge with said second side edge and a second recess at an intersection of said second end edge with said first side edge.

16. The transfer ring of claim 15, each said first protrusion of each said shoe extending sufficiently along a circumferential dimension of said cylindrical gripping surface as to overlap said second protrusion of said adjacent shoe along a zone parallel to said central axis of said cylindrical gripping surface.

17. The transfer ring of claim 10, each said first end edge of each said shoe defining a shape which differs from said first end edges of said remaining shoes, each said second end edge of each said shoe being keyed to said first end edge of said adjacent shoe.

18. A transfer ring comprising:
a circular frame;
a plurality of elongated driven links, each said driven link having a first end rotatably mounted along said circular frame such that each said driven link is rotatable between a contracted position and an expanded position;
a drive member disposed along said circular frame, said drive member being in operable engagement with said driven links and configured to drive said driven links between said contracted position and said expanded position; and
a plurality of shoes having arcuate interior surfaces facing substantially radially inwardly toward a central axis to collectively define a substantially cylindrical segmented gripping surface, each said shoe being rotatably mounted to one of said driven links at a second end thereof, each said shoe arcuate interior surface having a first arcuate edge and an opposite second arcuate edge arranged substantially parallel to one another and opposite first and second end edges extending between respective ends of said first and second arcuate edges, each said first and second end edge having at least a portion thereof extending non-parallel to said central axis.

19. The transfer ring of claim 18, each said first and second end edge of each said shoe defining a non-linear shape.

20. The transfer ring of claim 19, each said first and second end edges of each said shoe defining a plurality of alternating protrusions and recesses extending generally along a circumferential dimension of said cylindrical gripping surface.
